(19) United States
(12) Patent Application Publication
(10) Pub. No.: US 2007/0035637 A1
(43) Pub. Date: Feb. 15, 2007

(54) Method for color filter array demosaicking

(75) Inventors: Xiaoguang Feng, Shanghai (CN); Benhao Zhang, Shanghai (CN); Jing Hu, Shanghai (CN); Fu-Huei Lin, Cupertino, CA (US)

Correspondence Address: PERKINS COIE LLP;PATENT-SEA, P.O. BOX 1247, SEATTLE, WA, 98111-1247, US

(73) Assignee: Speadtrum Communications Corporation, Sunnyvale, CA (US)

(21) Appl. No.: 11/501,674

(22) Filed: Aug. 8, 2006

(30) Foreign Application Priority Data
Aug. 10, 2005 (CN) 200510028663.5

(51) Int. Cl. H04N 9/73

(52) U.S. Cl. 348/223.1

(57) ABSTRACT

This invention provides a method of interpolating a color filter array (CFA), which combines the advantages of the interpolation method based on edge detection and the interpolation method which utilizes the original color of each CFA pixel as reference, in order to ensure that the edges of the output image are clear and there are no obvious color artifacts. The interpolation method in this invention is computationally efficient and appropriate for real-time applications, in that only a 5×5 linear interpolation template is calculated and applied for each pixel.

### FIELD OF THE INVENTION

This invention is concerned with image creation in digital cameras, and in particular, with a color filter array (CFA) interpolation method.

### BACKGROUND

Most digital cameras utilize a structure of single image sensors fitted with a color filter array (CFA), in which there is only one color value at each pixel to capture a color representation of a scene using a single sensor. One such CFA is described in U.S. Pat. No. 3,971,065 to Bayer, which is hereby incorporated by reference. In the Bayer CFA, each pixel only captures one color: red, green or blue. To render a full-color image, an interpolation process is required. The efficacy of the interpolation algorithm determines the quality of the output image.

One interpolation method, based on edge detection, requires that interpolation proceed along the direction of the edge, rather than perpendicular to the edge direction, in order to ensure that the interpolation result edge is clear. However, this interpolation method often produces obvious color artifacts at the high frequency image details.

Under another interpolation method, which utilizes the original color of each CFA pixel as reference, the CFA color values corresponding to the original pixels before the interpolation process are considered to be correct, and therefore are used as the reference for the interpolation. However, this method often produces obvious zigzag effects at the image edges.

### SUMMARY OF THE INVENTION

This invention is to provide an interpolation method for CFA demosaicking. This method combines the advantages of the interpolation method based on edge detection and the interpolation method which utilizes the original color of CFA pixel as reference, in order to ensure that edges in the output image are clear and that there are no obvious color artifacts in the output color image.

In one embodiment as presented in the following part of this invention, the Bayer CFA is referred to as the CFA pattern. However, as a person skilled in the art will recognize, other CFA patterns may also be used within the principle of this invention and therefore should fall into the category of this invention. References to the Bayer CFA herein should be understood to be merely an example.

In order to solve the above problem, this invention provides a method for interpolating color values in a CFA pattern. The method for interpolating the green value at red or blue pixels comprises the steps described below.

First, use edge detection methods to decide the direction of green value interpolation at red or blue pixels.

If the interpolation should be applied in the vertical direction, the green value at the center pixel can be interpolated by 5 neighboring pixels which have this pixel as the center in the vertical direction:

$${G}_{13} = \frac{- {I}_{3} + 2 ⨯ {I}_{8} + 2 ⨯ {I}_{13} + 2 ⨯ {I}_{18} - {I}_{23}}{4}$$

where Iᵢ is the pixel value of each neighboring pixel and G₁₃ is the green value of the central pixel.

If the interpolation should be applied in the horizontal direction, the green value at the central pixel is interpolated by the five neighboring pixels which have this pixel as the center in the horizontal direction.

$${G}_{13} = \frac{- {I}_{11} + 2 ⨯ {I}_{12} + 2 ⨯ {I}_{13} + 2 ⨯ {I}_{14} - {I}_{15}}{4}$$

where Iᵢ is the pixel value of each neighboring pixel and G₁₃ is the green value of the central pixel.

If the interpolation should be applied in both vertical and horizontal directions, the green value at the central pixel is interpolated by the nine neighboring pixels which have this pixel as the center both in the vertical direction and in the horizontal direction.

$${G}_{13} = \frac{\begin{matrix}- {I}_{3} + 2 ⨯ {I}_{8} + 2 ⨯ {I}_{12} + 2 ⨯ {I}_{14} - \\ {I}_{15} - {I}_{11} + 2 ⨯ {I}_{18} + 4 ⨯ {I}_{13} - {I}_{23}\end{matrix}}{4}$$

where Iᵢ is the pixel value of each neighboring pixel and G₁₃ is the green value of the central pixel 13.

The interpolation method in this invention will produce high-quality output images with clear edges and no color artifacts. It is computationally efficient and appropriate for real-time applications, in that only a 5×5 linear interpolation template is calculated and applied for each pixel.

### BRIEF DESCRIPTION OF THE DRAWINGS

FIG. 1 is a 5×5 original Bayer CFA image in which the center is a red pixel.

FIG. 2 is the green value interpolation template in the vertical direction.

FIG. 3 is the green value interpolation template in the horizontal direction.

FIG. 4 is the green value interpolation template in both vertical and horizontal directions.

FIG. 5 is the “#”-shaped blue value interpolation template.

FIG. 6 is a 5×5 original Bayer CFA image in which the center is a green pixel.

FIG. 7 is the double-cross-shaped blue value interpolation template when the center is a green pixel.

FIG. 8 is the double-cross-shaped red value interpolation template when the center is a green pixel.

### DESCRIPTION OF THE PREFERRED EMBODIMENT

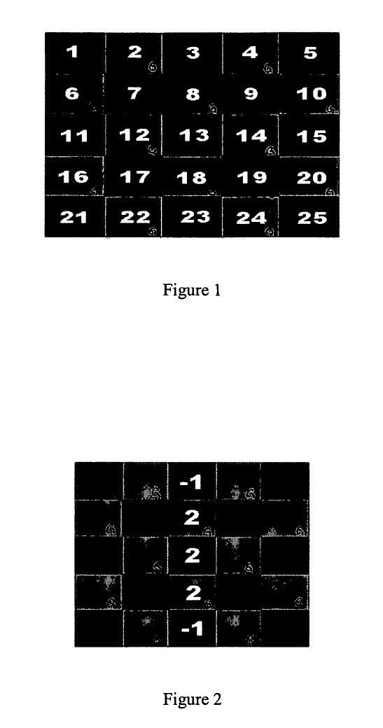

FIG. 1 shows a 5×5 Bayer CRA image in which the center is a red pixel. The method is implemented differently depending on whether the center is a red, blue or green pixel. The following will describe the method for each situation.

1. Interpolate the green value and blue value at the red pixel (e.g. The central pixel 13, as shown on FIG. 1)

1) Step 1, interpolate the green value at the central pixel 13.

First, determine the direction of green value interpolation of the central pixel 13 (horizontal, vertical or both) by determining whether there is an edge present. First, gradients near the pixel are calculated according to:
Δₕ=|2×I₁₃−I₁₁−I₁₅|+|I₁₂−I₁₄| [1]
Δᵥ=|2×I₁₃−I₃−I₂₃|+|I₈−I₁₈| [2]

where Iᵢ is the pixel value at each pixel in FIG. 1, Δₕ is the second order gradient value in the horizontal direction, and Δᵥ is the second order gradient value in the vertical direction.

If Δₕ−Δᵥ is larger than a positive threshold T, interpolate in the vertical direction;

If Δₕ−Δᵥ is smaller than a negative threshold −T, interpolate in the horizontal direction;

In other cases, interpolate in both directions.

The edge direction estimation method described herein is provided merely as an example and should not be construed as limiting the scope of the invention. Other edge direction estimation methods can also be applied to this invention and therefore should fall into the category of this invention.

1.1) If Δₕ−Δᵥ>T

Based on the “original CFA color reference” interpolation method (the second method described in the background section), we use the original red value at the center as a reference. The color difference of the green value and red value should be equal to the mean of the green value and the red value differences of the upper and lower neighbor pixels.

$${G}_{13} - {R}_{13} = \frac{( {G}_{8} - {R}_{8} ) + ( {G}_{18} - {R}_{18} )}{2}$$

Simplifying the formula yields:

$${G}_{13} = {R}_{13} + \frac{( {G}_{8} - {R}_{8} ) + ( {G}_{18} - {R}_{18} )}{2}$$

Where R₈ and R₁₈ and are unknown, they can be estimated by the mean of the red values of the upper and lower neighbor pixels.

$${R}_{8} = \frac{{R}_{3} + {R}_{13}}{2}$$

$${R}_{18} = \frac{{R}_{13} + {R}_{23}}{2}$$

Simplifying the formula, we get:

$${G}_{13} = \frac{- {I}_{3} + 2 ⨯ {I}_{8} + 2 ⨯ {I}_{13} + 2 ⨯ {I}_{18} - {I}_{23}}{4} \qquad [ 3 ]$$

Therefore, it can be seen that the green value of the central pixel 13 can be interpolated by the five neighboring pixels 3, 8, 13, 18, 23, which have pixel 13 as the center at the vertical direction. Herein Iᵢ is the pixel value at each pixel in FIG. 1, and G₁₃ is the green value at the central pixel 13.

The formula [3] can be represented as the linear interpolation template in FIG. 2. Each value on the template multiplied by ¼ is the interpolation coefficient of the corresponding pixel in formula [3] (e.g. the coefficient of the pixel 3 in the formula [3] is −¼, while that of the pixel 8 is 2/4).

1.2) Similarly, if Δₕ−Δᵥ<−T, the green value of the central pixel 13 should be interpolated by the five neighboring pixels 11, 12, 13, 14, 15 which have pixel 13 as the center in the horizontal direction.

$${G}_{13} = \frac{- {I}_{11} + 2 ⨯ {I}_{12} + 2 ⨯ {I}_{13} + 2 ⨯ {I}_{14} - {I}_{15}}{4} \qquad [ 4 ]$$

Herein Iᵢ is the pixel value at each pixel in FIG. 1, and G₁₃ is the green value at the central pixel 13.

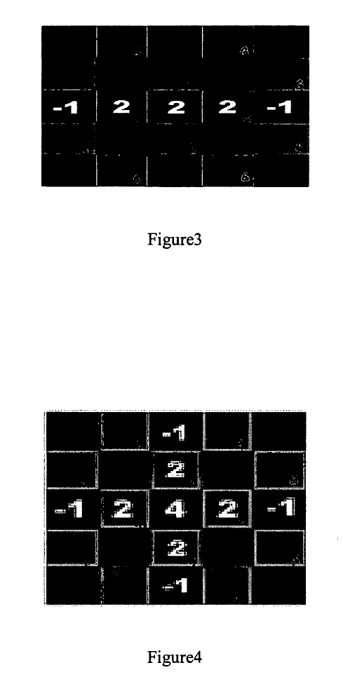

The formula [4] can be represented as the linear interpolation template in FIG. 3. Each value on the template multiplied by ¼ is the interpolation coefficient of the corresponding pixel in formula [4] (e.g. the coefficient of the pixel 11 in the formula [4] is −¼, while that of the pixel 12 is 2/4).

1.3) Similarly, if |Δₕ−Δᵥ|<T, the green value of the central pixel 13 should be interpolated by nine pixels 3, 8, 11, 12, 13, 14, 15, 18, 23 which have pixel 13 as the center in both directions.

$${G}_{13} = \frac{\begin{matrix}- {I}_{3} + 2 ⨯ {I}_{8} + 2 ⨯ {I}_{12} + 2 ⨯ {I}_{14} - \\ {I}_{15} - {I}_{11} + 2 ⨯ {I}_{18} + 4 ⨯ {I}_{13} - {I}_{23}\end{matrix}}{4} \qquad [ 5 ]$$

Herein Iᵢ is the pixel value at each pixel in FIG. 1, and G₁₃ is the green value at the central pixel 13.

The formula [5] can be represented as the linear interpolation template in FIG. 4. The value at each pixel on the template multiplied by ¼ is the interpolation coefficient of the corresponding pixel in formula [4] (e.g. the coefficient of the pixel 11 in the formula [5] is −¼, while that of the pixel 12 is 2/4).

2) Step 2: interpolate the blue value at the central pixel 13.

The blue value may then be calculated in a similar fashion. Based on the “original CFA color reference” interpolation method (the second method described in the background section), we use the original green value at the center as a reference. The color difference of its blue value and green value should be equal to the mean of the blue value and the green value differences of its four neighboring pixels.

$${B}_{13} - {G}_{13} = \frac{{\sum }_{i = 7 , 9 , 17 , 19} ( {B}_{i} - {G}_{i} )}{4}$$

Simplifying the formula, we get:

$${B}_{13} - {G}_{13} + \frac{{\sum }_{i = 7 , 9 , 17 , 19} ( {B}_{i} - {G}_{i} )}{4}$$

Herein G₇, G₉, G₁₇, and G₁₉ can be estimated by its own neighboring pixel (using the same “color difference mean” method.)

$${G}_{7} = {B}_{7} + \frac{\begin{matrix}( {G}_{2} - {B}_{7} ) + ( {G}_{6} - {B}_{7} ) + \\ ( {G}_{8} - \frac{{B}_{7} + {B}_{9}}{2} ) + \\ ( {G}_{12} - \frac{{B}_{7} + {B}_{17}}{2} )\end{matrix}}{4}$$

$${G}_{9} = {B}_{9} + \frac{\begin{matrix}( {G}_{4} - {B}_{9} ) + ( {G}_{10} - {B}_{9} ) + \\ ( {G}_{8} - \frac{{B}_{7} + {B}_{9}}{2} ) + \\ ( {G}_{14} - \frac{{B}_{9} + {B}_{19}}{2} )\end{matrix}}{4}$$

$${G}_{17} = {B}_{17} + \frac{\begin{matrix}( {G}_{22} - {B}_{17} ) + ( {G}_{16} - {B}_{17} ) + \\ ( {G}_{18} - \frac{{B}_{17} + {B}_{19}}{2} ) + \\ ( {G}_{12} - \frac{{B}_{7} + {B}_{17}}{2} )\end{matrix}}{4}$$

$${G}_{19} = {B}_{19} + \frac{\begin{matrix}( {G}_{24} - {B}_{19} ) + ( {G}_{20} - {B}_{19} ) + \\ ( {G}_{18} - \frac{{B}_{17} + {B}_{19}}{2} ) + \\ ( {G}_{14} - \frac{{B}_{9} + {B}_{19}}{2} )\end{matrix}}{4}$$

The formula can be simplified as:

$${B}_{13} = {G}_{13} + \frac{1}{16} ( - ( {I}_{2} + {I}_{4} + {I}_{4} + {I}_{10} + {I}_{16} + {I}_{20} + {I}_{22} + {I}_{24} ) - 2 * ( {I}_{8} + {I}_{12} + {I}_{14} + {I}_{18} ) + 4 * ( {I}_{7} + {I}_{9} + {I}_{17} + {I}_{19} ) ) \qquad [ 6 ]$$

Formula [6] can then be simplified as B₁₃=G₁₃+A, where B₁₃ is the blue value of the central pixel 13 which is to be calculated and A can be interpolated from the 16 pixels 2, 4, 6, 7, 8, 9, 10, 12, 14, 16, 17, 18, 19, 20, 22, 24, which represent a “#” shape centered at the pixel 13.

The formula [6] can be represented as the “#”-shaped interpolation template in FIG. 5. Each value on the template multiplied by 1/16 is the interpolation coefficient of the pixel in formula [6] respectively (e.g. the coefficient of the pixel 7 in the formula [6] is 4/16, while that of the pixel 8 is − 2/16).

2. Interpolate the green value and red value at the blue pixel:

The method of interpolating the green value at the blue pixel is the same as that of interpolating the green value at the red pixel and therefore will not be repeated herein.

The method of interpolating the red value at a blue pixel is the same as that of interpolating the blue value at a red pixel:

R₁₃=G₁₃+A, where R₁₃ is the red value at the pixel 13 to be calculated, G₁₃ is the already interpolated green value at the pixel 13, and A is interpolated by the 16 neighboring pixels 2, 4, 6, 7, 8, 9, 10, 12, 14, 16, 17, 18, 19, 20, 22, 24, which represent a “#” shape centered at the pixel 13.

$$A = \frac{1}{16} ( - ( {I}_{2} + {I}_{4} + {I}_{6} + {I}_{10} + {I}_{16} + {I}_{20} + {I}_{22} + {I}_{24} ) - 2 * ( {I}_{8} + {I}_{12} + {I}_{14} + {I}_{18} ) + 4 * ( {I}_{7} + {I}_{9} + {I}_{17} + {I}_{19} + ) )$$

where Iᵢ is the value at the each pixel.

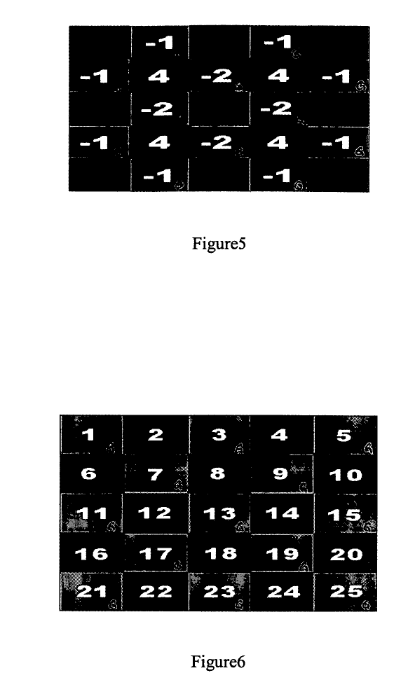

3. To interpolate Red and Blue values at G pixel (in G R G R line), as the center pixel in FIG. 6.

3.1 To interpolate the blue value at pixel 13.

Based on the “original CFA color reference” interpolation method (the second method described in the background section), we use the original green value at the center pixel as a reference. The color difference of the blue value and green value should be equal to the mean of the blue value and the green value differences of the two neighboring pixels.

$${B}_{13} = {G}_{13} + \frac{{\sum }_{i = 8 , 18} ( {B}_{i} - {G}_{i} )}{2}$$

Herein G₈ and G₁₈ can be estimated by its own neighboring pixel (the same “color mean idea”).

$${G}_{8} = {B}_{8} + \frac{\begin{matrix}( {G}_{3} - {B}_{8} ) + ( {G}_{7} - \frac{{B}_{6} + {B}_{8}}{2} ) + \\ ( {G}_{9} - \frac{{B}_{8} + {B}_{10}}{2} ) + \\ ( {G}_{13} - \frac{{B}_{8} + {B}_{18}}{2} )\end{matrix}}{4}$$

$${G}_{18} = {B}_{18} + \frac{\begin{matrix}( {G}_{23} - {B}_{18} ) + ( {G}_{17} - \frac{{B}_{16} + {B}_{18}}{2} ) + \\ ( {G}_{19} - \frac{{B}_{18} + {B}_{20}}{2} ) + \\ ( {G}_{13} - \frac{{B}_{8} + {B}_{18}}{2} )\end{matrix}}{4}$$

The above formula can be simplified as:

$${B}_{13} = {G}_{13} + \frac{1}{8} ( - ( {I}_{3} + {I}_{7} + {I}_{9} + {I}_{17} + {I}_{19} + {I}_{23} ) + \frac{1}{2} * ( {I}_{6} + {I}_{10} + {I}_{16} + {I}_{20} ) + 3 * ( {I}_{8} + {I}_{18} ) - 2 * {I}_{13} ) \qquad [ 7 ]$$

Herein B₁₃=G₁₃+A, where B₁₃ is the blue value at the central pixel 13 which is to be calculated, G₁₃ is the green value at this pixel, and A is interpolated from the neighboring 13 pixels 3, 6, 7, 8, 9, 10, 13, 16, 17, 18, 19, 20, 23, which represent a double cross shape centered at the pixel 13.

The formula [7] can be represented as the double cross shaped interpolation template in FIG. 7. Each value on the template multiplied by ⅛ is the interpolation coefficient of the corresponding pixel in formula [7] (e.g. the coefficient of the pixel 7 in the formula [7] is −⅛, while that of the pixel 8 is ⅜).

3.2) Similarly, interpolate the red value at the central pixel 13.

Herein R₁₃=G₁₃+A, where R₁₃ is the red value at the central pixel 13 which is to be calculated, G₁₃ is the green value at this pixel, and A is interpolated from the neighboring 13 pixels 2, 4, 7, 9, 11, 12, 13, 14, 15, 17, 19, 22, 24, which represent a double cross shape centered at the pixel 13.

$$A = \frac{1}{8} ( - ( {I}_{7} + {I}_{9} + {I}_{11} + {I}_{15} + {I}_{17} + {I}_{19} ) + \frac{1}{2} * ( {I}_{2} + {I}_{4} + {I}_{22} + {I}_{24} ) + 3 * ( {I}_{12} + {I}_{14} ) - 2 * {I}_{13} ) \qquad [ 8 ]$$

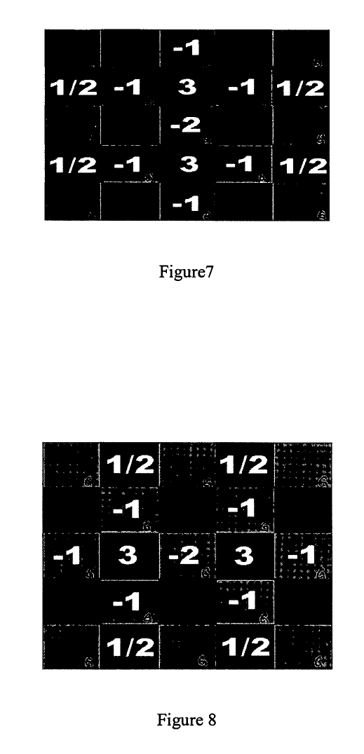

The formula [8] can be represented as the double cross shaped interpolation template in FIG. 8. The value at each pixel on the template multiplied by ⅛ is the interpolation coefficient of the corresponding pixel in formula [8] (e.g. the coefficient of the pixel 7 in the formula [7] is −⅛, while that of the pixel 12 is ⅜).

4. To interpolate Red and Blue values at green pixel in B G B G line is the same as to interpolate red and blue values in G R G R line.

The exemplary embodiments described herein are provided merely to illustrate the principles of the invention and should not be construed as limiting the scope of the invention. Any improvement or modification of this invention by a person skilled in the art based on the principle of this invention should fall into the category of this invention.

What is claimed is:

1. A method for interpolating pixel values during CFA demosaicking comprising:
determining a direction of green value interpolation;
if interpolating vertically, interpolating the green value according to the formula
$${G}_{13} = \frac{- {I}_{3} + 2 \times {I}_{8} + 2 \times {I}_{13} + 2 \times {I}_{18} - {I}_{23}}{4}$$
where Iᵢ is the pixel value of each neighboring pixel and G₁₃ is the green value of the central pixel;
if interpolating horizontally, interpolating the green value according to the formula
$${G}_{13} = \frac{- {I}_{11} + 2 \times {I}_{12} + 2 \times {I}_{13} + 2 \times {I}_{14} - {I}_{15}}{4}$$
where Iᵢ is the pixel value of each neighboring pixel and G₁₃ is the green value of the central pixel; and
if interpolating both horizontally and vertically, interpolating the green value according to the formula
$${G}_{13} = \frac{- {I}_{3} + 2 \times {I}_{8} + 2 \times {I}_{12} + 2 \times {I}_{14} - {I}_{15} - {I}_{11} + 2 \times {I}_{18} + 4 \times {I}_{13} - {I}_{23}}{4}$$
where Iᵢ is the pixel value of each neighboring pixel and G₁₃ is the green value of the central pixel.

2. The method of claim 1, wherein the step of determining a direction of green value interpolation comprises the steps of:
determining a second order gradient value in the horizontal direction according to the formula
Δₕ=|2×I₁₃−I₁₁I₁₅|+|I₁₂−I₁₄|;
determining a second order gradient value in the vertical direction according to the formula
Δᵥ=|2×I₁₃−I₃−I₂₃|+|I₈−I₁₈|;
interpolating vertically if Δₕ−Δᵥ is larger than a positive threshold;
interpolating horizontally if Δₕ−Δᵥ is smaller than a negative threshold; and
interpolating horizontally and vertically in all other cases.

3. The method of claim 1, further comprising the step of:
interpolating the blue value at a red pixel according to the formula
B₁₃=G₁₃+A,
where B₁₃ is the blue value of the central pixel 13 which is to be calculated, G₁₃ is the green value of the central pixel 13 and A is calculated according to the formula
$$A = \frac{1}{16} ( - ( {I}_{2} + {I}_{4} + {I}_{6} + {I}_{10} + {I}_{16} + {I}_{20} + {I}_{22} + {I}_{24} ) - 2 \times ( {I}_{8} + {I}_{12} + {I}_{14} + {I}_{18} ) + 4 \times ( {I}_{7} + {I}_{9} + {I}_{17} + {I}_{19} ) )$$
where Iᵢ is the value at the each pixel.

4. The method of claim 1, further comprising the step of:
interpolating the red value at a blue pixel according to the formula
R₁₃=G₁₃+A,
where R₁₃ is the red value of the central pixel 13 which is to be calculated, G₁₃ is the green value of the central pixel 13 and A is calculated according to the formula
$$A = \frac{1}{16} ( - ( {I}_{2} + {I}_{4} + {I}_{6} + {I}_{10} + {I}_{16} + {I}_{20} + {I}_{22} + {I}_{24} ) - 2 \times ( {I}_{8} + {I}_{12} + {I}_{14} + {I}_{18} ) + 4 \times ( {I}_{7} + {I}_{9} + {I}_{17} + {I}_{19} ) )$$
where Iᵢ is the value at the each pixel.

5. The method of claim 1, further comprising the steps of:
interpolating the red value at a green pixel according to the formula
R₁₃=G₁₃+A,
where R₁₃ is the red value of the central pixel 13 which is to be calculated, G₁₃ is the green value of the central pixel 13 and A is calculated according to the formula
$$A = \frac{1}{8} ( - ( {I}_{7} + {I}_{9} + {I}_{11} + {I}_{15} + {I}_{17} + {I}_{19} ) + \frac{1}{2} * ( {I}_{2} + {I}_{4} + {I}_{22} + {I}_{24} ) + 3 * ( {I}_{12} + {I}_{14} ) - 2 * {I}_{13} )$$
where Iᵢ is the value at the each pixel.

6. The method of claim 1, further comprising the steps of:
interpolating the blue value at a green pixel according to the formula
B₁₃=G₁₃+A,
where B₁₃ is the blue value of the central pixel 13 which is to be calculated, G₁₃ is the green value of the central pixel 13 and A is calculated according to the formula
$$A = \frac{1}{8} ( - ( {I}_{3} + {I}_{7} + {I}_{9} + {I}_{17} + {I}_{19} + {I}_{23} ) + \frac{1}{2} * ( {I}_{6} + {I}_{10} + {I}_{16} + {I}_{20} ) + 3 * ( {I}_{8} + {I}_{18} ) - 2 * {I}_{13} )$$
where Iᵢ is the value at the each pixel.
